(19) United States
(12) Patent Application Publication
(10) Pub. No.: US 2017/0315963 A1
(43) Pub. Date: Nov. 2, 2017

(54) IMAGE PROCESSING APPARATUS AND IMAGE PROCESSING SYSTEM

(71) Applicant: KYOCERA Document Solutions Inc., Osaka (JP)

(72) Inventors: Naoto HANATANI, Osaka (JP); Sachiko YOSHIMURA, Osaka (JP); Yumi NAKAGOSHI, Osaka (JP); Akihiro UMENAGA, Osaka (JP); Hironori HAYASHI, Osaka (JP)

(73) Assignee: KYOCERA Document Solutions Inc., Osaka (JP)

(21) Appl. No.: 15/493,643

(22) Filed: Apr. 21, 2017

(30) Foreign Application Priority Data
Apr. 28, 2016 (JP) 2016-091227

(51) Int. Cl. G06F 17/21; G06K 9/00; G06K 9/18; G06T 11/00

(52) U.S. Cl. CPC G06F 17/211; G06T 11/001; G06K 9/00463; G06K 9/18; G06K 2209/01

(57) ABSTRACT

An image processing apparatus includes an acquisition section, a marker detecting section, a text extracting section, and a markup language processing section. The marker detecting section detects, based on the image data acquired by the acquisition section, a marker assigned to an original document. The text extracting section analyzes the image data to recognize and extract a text in the original document. The markup language processing section generates markup data in which the text in the image data has the same display color as the marker.

### INCORPORATION BY REFERENCE

This application claims priority to Japanese Patent Application No. 2016-091227 filed on Apr. 28 2016, the entire disclosure of which is incorporated herein by reference.

### BACKGROUND

The present disclosure relates to image processing apparatuses and image processing systems for scanning an original document and extracting a text in this original document and particularly relates to a technique for utilizing a marker assigned to the text.

A technique is known for scanning an original document, detecting a marker assigned to this original document, recognizing a region of the original document enclosed by a marker, and printing the inside or outside of this region.

### SUMMARY

A technique improved over the above technique is proposed herein as one aspect of the present disclosure.

An image processing apparatus according to an aspect of the present disclosure includes an acquisition section, a marker detecting section, a text extracting section, and a markup language processing section. The acquisition section acquires image data representing an image of an original document. The marker detecting section detects, based on the image data, a marker assigned to the original document. The text extracting section analyzes the image data to recognize and extract a text in the original document. The markup language processing section generates markup data written in a markup language and containing: the text extracted by the text extracting section; and data representing a display manner of the marker detected by the marker detecting section and generates as the markup data markup data in which the text in the image data has the same display color as the marker.

An image processing system according to another aspect of the present disclosure is an image processing system that performs data communication between an image processing apparatus and an information processing apparatus and includes the above-described image processing apparatus and an information processing apparatus. The information processing apparatus includes: a receiving section that receives the markup data; and a display section that displays, based on the markup data, the text together with the marker.

### BRIEF DESCRIPTION OF THE DRAWINGS

FIG. 1 is a perspective view showing the appearances of an image forming apparatus and an information processing apparatus in an image processing system according to an embodiment of the present disclosure.

FIG. 2 is a block diagram showing the configurations of the image forming apparatus and the information processing apparatus in the image processing system according to the above embodiment.

FIG. 3A is a view showing a text and markers in an original document scanned on the image forming apparatus and FIG. 3B is a view showing a text and markers displayed on a display section of the information processing apparatus.

FIGS. 4A to 4C are views showing the text and markers when character strings at marker locations in the text are changed in display color on a color-by-color basis of red, yellow, and green markers.

FIG. 5 is a flowchart showing a processing procedure on the image forming apparatus for recognizing and extracting a text in an original document, converting the display manners of character strings at marker locations and the display manners of the markers into a markup language, and sending markup data by an e-mail.

FIG. 6 is a plan view showing an operating section and a display section of the image forming apparatus.

FIG. 7 is a flowchart showing a processing procedure on the information processing apparatus for receiving the e-mail, interpreting the markup language in the body of the e-mail, displaying the text together with the markers, and switching the color of a character string at a marker location to a different color in response to pointing at the marker location.

FIG. 8 is a view showing an example of text data generated by a markup language processing section on the image forming apparatus.

### DETAILED DESCRIPTION

Hereinafter, a description will be given of an embodiment of the present disclosure with reference to the drawings.

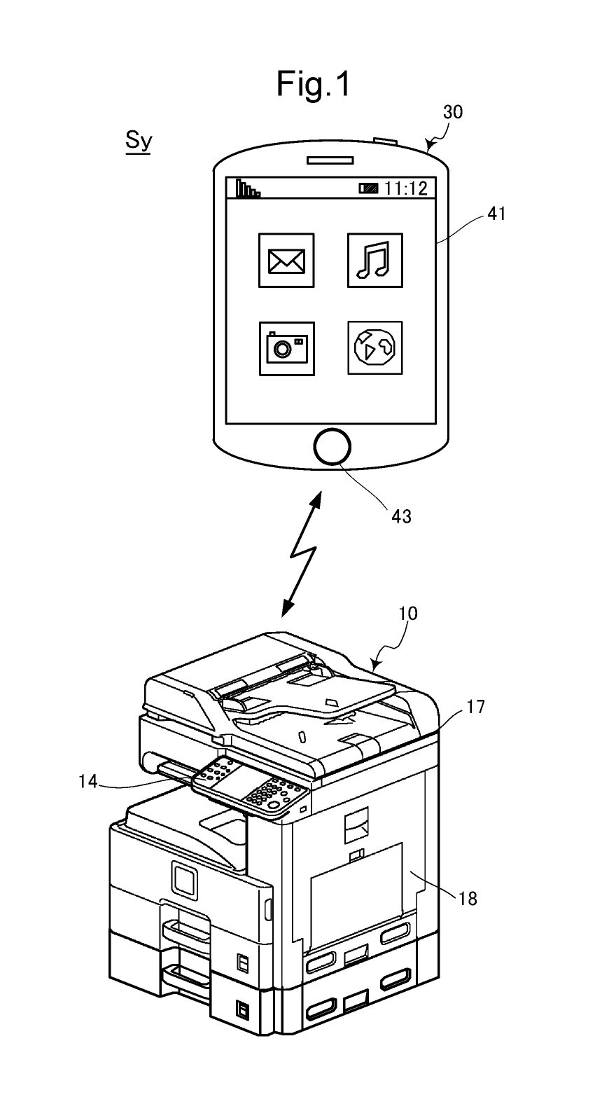

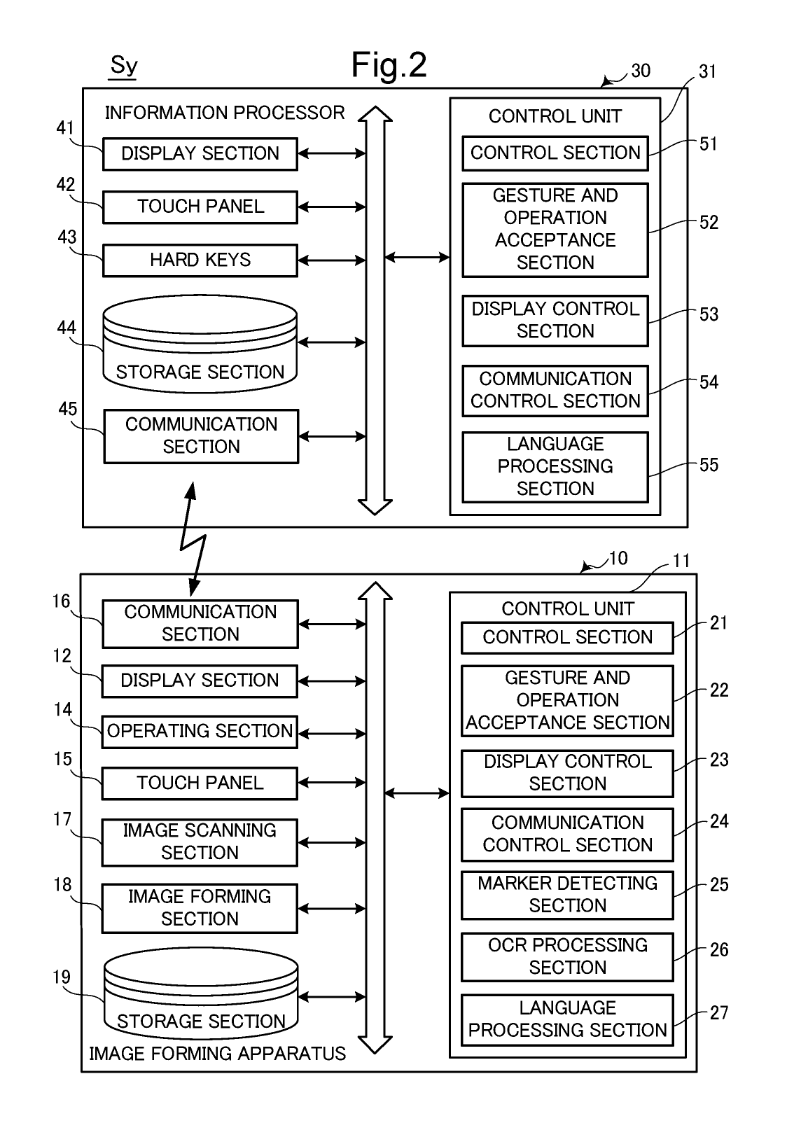

FIG. 1 is a perspective view showing the appearances of an image forming apparatus and an information processing apparatus in an image processing system according to an embodiment of the present disclosure. FIG. 2 is a block diagram showing the configurations of the image forming apparatus and the information processing apparatus in the image processing system according to this embodiment.

In an image processing system Sy of this embodiment, an image forming apparatus 10 includes a control unit 11, a display section 12, an operating section 14, a touch panel 15, a communication section 16, an image scanning section 17, an image forming section 18, and a storage section 19. These components can transfer data or signals to each other via a bus.

The image scanning section 17 (the acquisition section) includes a scanner for optically scanning an original document placed on an original glass plate and generates image data representing an image of the original document. Instead of acquiring image data in a manner that the image scanning section 17 scans an original document, the image forming apparatus 10 may acquire image data representing an original document in a manner that the communication section 16 receives the image data from an information processing apparatus, such as a PC (personal computer).

The image forming section 18 includes a photosensitive drum, a charging device operable to uniformly charge the surface of the photosensitive drum, an exposure device operable to expose the surface of the photosensitive drum to light to form an electrostatic latent image on the surface thereof, a developing device operable to develop the electrostatic latent image on the surface of the photosensitive drum into a toner image, and a transfer device operable to transfer the toner image (the image) on the surface of the photosensitive drum to a recording paper sheet as a recording medium and prints on the recording paper sheet the image represented by the image data generated by the image scanning section 17.

The display section 12 is formed of a liquid crystal display (LCD), an organic light-emitting diode (OLED) display or the like.

The touch panel 15 is disposed on the screen of the display section 12. The touch panel 15 is a touch panel of, for example, a so-called resistive film system or a capacitance system and detects a touch of the touch panel 15 with a user's finger or the like, together with the point of touch.

The operating section 14 includes, for example, a menu key for calling up a menu, arrow keys for moving the focus of a GUI forming the menu, a determination key for performing a determination operation for the GUI forming the menu, and a start key.

The communication section 16 is a communication interface including a communication module.

The storage section 19 is a large storage device, such as an HDD (hard disk drive).

The control unit 11 is formed of a CPU (central processing unit), a RAM (random access memory), a ROM (read only memory), and so on. When a program stored in the above ROM or storage section 19 is executed by the above CPU, the control unit 11 functions as a control section 21, a gesture and operation acceptance section 22, a display control section 23, a communication control section 24, a marker detecting section 25, an OCR processing section 26, and a markup language processing section 27. Alternatively, each constituent section of the control unit 11 may not be implemented by the operation of the control unit 11 in accordance with the program but may be constituted by a hardware circuit.

The control section 21 governs the overall operation control of the image forming apparatus 10.

The gesture and operation acceptance section 22 has the function to accept a user's gesture on the touch panel 15 based on a detection signal output from the touch panel 15. Furthermore, the gesture and operation acceptance section 22 also has the function to accept a user's operation of each of the hard keys of the operating section 14.

The display control section 23 controls the display section 12 to allow the display section 12 to display an entry screen for inputting setting items necessary for image formation processing or an entry screen for inputting information.

The communication control section 24 has the function to control the communication operation of the communication section 16. The communication section 16 sends and receives data to and from an information processing apparatus 30 under the control of the communication control section 24.

The marker detecting section 25 has the function to detect, based on the image data representing the image of the original document acquired by the image scanning section 17, marker locations in the original document where markers are assigned.

The OCR processing section 26 (the text extracting section) has the function to analyze the image data to recognize and extract a text in the original document.

The markup language processing section 27 has the function to generate markup data written in a markup language and containing: the text extracted by the OCR processing section 26; and data representing the display manners of the markers detected by the marker detecting section 25. For example, the markup language processing section 27 generates markup data for setting the display manner of each of character strings at marker locations in a text and the display manner of each of the markers and for setting the function to switch one of both the display manners to a different display manner and interprets the markup data to set the display manners and switch the one of both the display manners to the different display manner. The markup language to be applied is, for example, HTML or JavaScript.

On the other hand, the information processing apparatus 30 in the image processing system Sy of this embodiment is, for example, a mobile terminal device, such as a smartphone, and includes a control unit 31, a display section 41, a touch panel 42 (the operating section), hard keys 43, a storage section 44, and a communication section 45. These components can transfer data or signals to each other via a bus.

The display section 41 is formed of a liquid crystal display (LCD), an organic light-emitting diode (OLED) display or the like.

The touch panel 42 is disposed on the screen of the display section 41. The touch panel 42 detects a touch of the touch panel 42 with a user's finger, together with the point of touch.

Furthermore, the information processing apparatus 30 includes, as the operating section through which a user's operation is input, the hard keys 43 in addition to the above touch panel 42.

The communication section 45 is a communication interface including a communication module.

The storage section 44 is a large storage device, such as a RAM (random access memory).

The control unit 31 is formed of a CPU (central processing unit), a RAM (random access memory), a ROM (read only memory), and so on. When a control program stored in the above ROM or storage section 44 is executed by the above CPU, the control unit 31 functions as a control section 51, a gesture and operation acceptance section 52, a display control section 53, a communication control section 54, and a markup language processing section 55. Alternatively, each constituent section of the control unit 31 may not be implemented by the operation of the control unit 31 in accordance with the above printer driver but may be constituted by a hardware circuit.

The control section 51 governs the overall operation control of the information processing apparatus 30.

The gesture and operation acceptance section 52 identifies a user's gesture or operation input by the user, based on a detection signal output from the touch panel 42 or an operation performed through one of the hard keys 43. Then, the gesture and operation acceptance section 52 accepts the identified user's gesture or operation and outputs a control signal corresponding to the user's gesture or operation to the control section 51, the display control section 53, the communication control section 54, the markup language processing section 55, and so on.

The display control section 53 controls the display section 41 to allow the screen of the display section 41 to display setting items necessary for information processing or display a text.

The communication control section 54 has the function to control the communication operation of the communication section 45. The communication section 45 sends and receives, under the control of the communication control section 54, data to and from the image forming apparatus 10.

The markup language processing section 55 interprets markup data associated with character strings at marker locations and markers in the text displayed on the screen of the display section 41 and sets and changes the display manners of the character strings at the marker locations and the display manners of the markers.

As described above, in the image forming apparatus 10, the image scanning section 17 scans an original document, the marker detecting section 25 detects marker locations in the original document where markers are assigned, the OCR processing section 26 recognizes a text in the original document, and the markup language processing section 27 generates markup data representing the display manners of character strings at the marker locations in the text and the display manners of the markers. This markup data is used for setting the display manners of the character strings at the marker locations and the display manners of the markers so that the character string at each marker location has the same color as the associated marker and for setting the function to switch, in response to pointing at any marker location, the color of the character string at the marker location to a different color. In other words, the markup data contains the text extracted by the OCR processing section 26, data representing the display manners (colors) of the text, data representing the display manners (colors) of the markers, a processing procedure for switching, in response to pointing at any marker location, either one of the color of the text portion at the marker location and the color of the associated marker to a different color, and so on.

Then, the communication control section 24 generates an e-mail addressed to the user of the information processing apparatus 30, inserts the markup data into the body of the e-mail, and sends the e-mail through the communication section 16 to the network.

When in the information processing apparatus 30 the communication section 45 receives the e-mail, the text in the body of the e-mail is displayed on the screen of the display section 41. Furthermore, the markup language processing section 55 interprets the markup data and sets the display manners of the character strings at the marker locations and the display manners of the markers. Thus, the text (containing the character strings at the marker locations) and the markers are displayed. In this situation, since the character string at each marker location and the associated marker are set at the same color based on the markup data as described above, the character strings at all the marker locations are invisible on the screen of the display section 12. In addition, the function to switch, in response to pointing at any marker location, the color of the character string at the marker location to a different color is set by the markup data. Therefore, when the user points at any marker location with a fingertip or the like on the screen of the display section 41, the display control section 53 switches the color of the character string at the marker location to a color different from the color of the marker, so that the character string becomes visible. This switching of colors of the character string is useful, for example, for memorizing the character string.

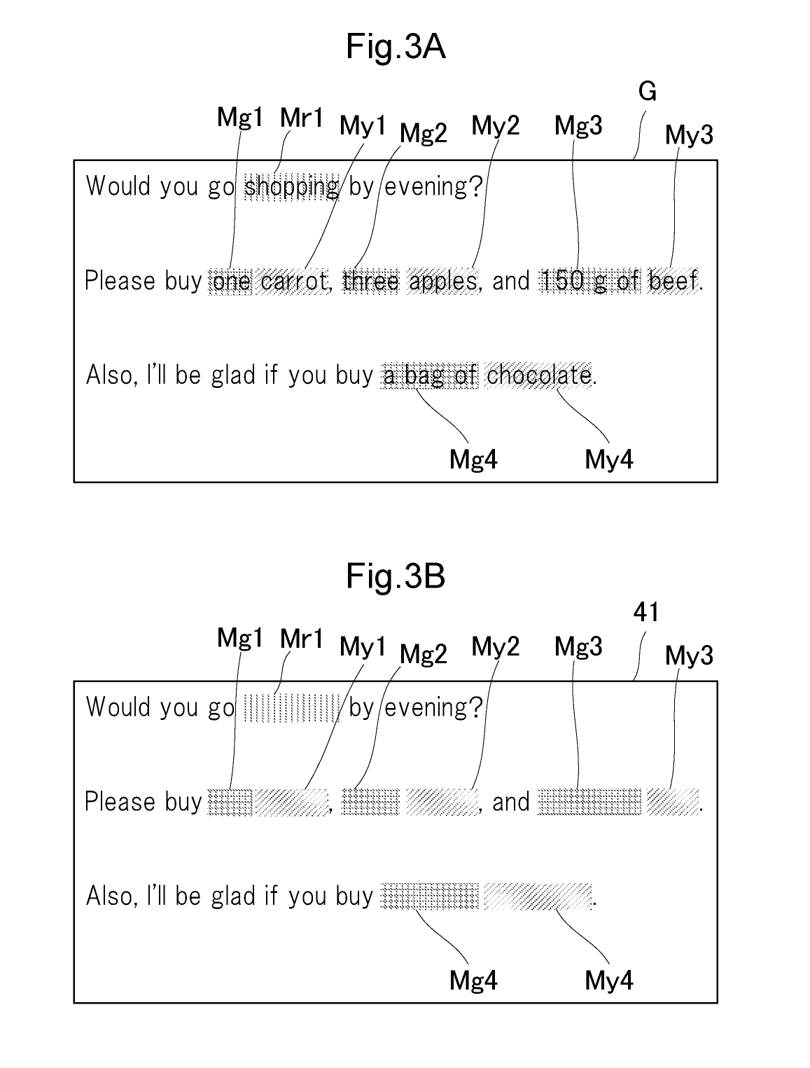

More specifically, suppose that in the image forming apparatus 10 a text of an original document G as shown in FIG. 3A is set to contain a marker location Mr1 where a red marker is assigned, four marker locations My1 to My4 where yellow markers are assigned, and four marker locations Mg1 to Mg4 where green markers are assigned. In this case, markup data is generated for setting, on a color-by-color basis of the red, yellow, and green markers, the character string at each marker location and the associated marker at the same color and for switching, in response to pointing at any marker location, the color of the character string at the marker location to black.

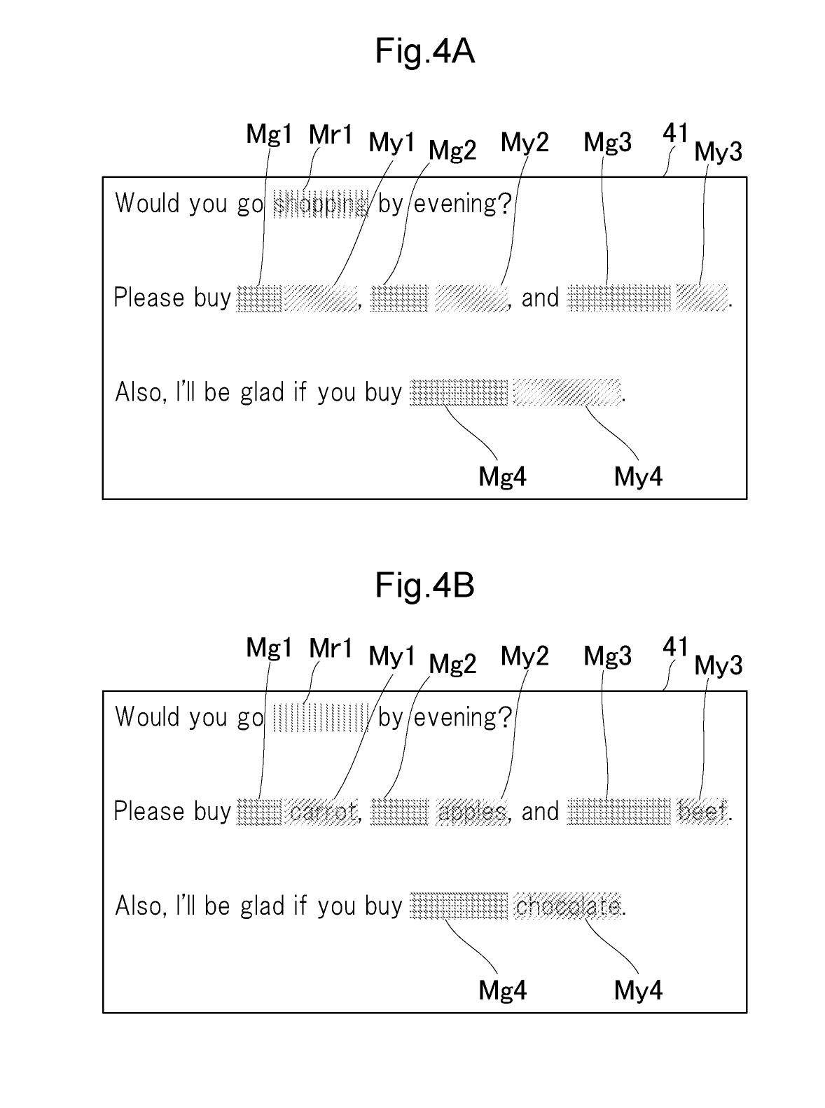

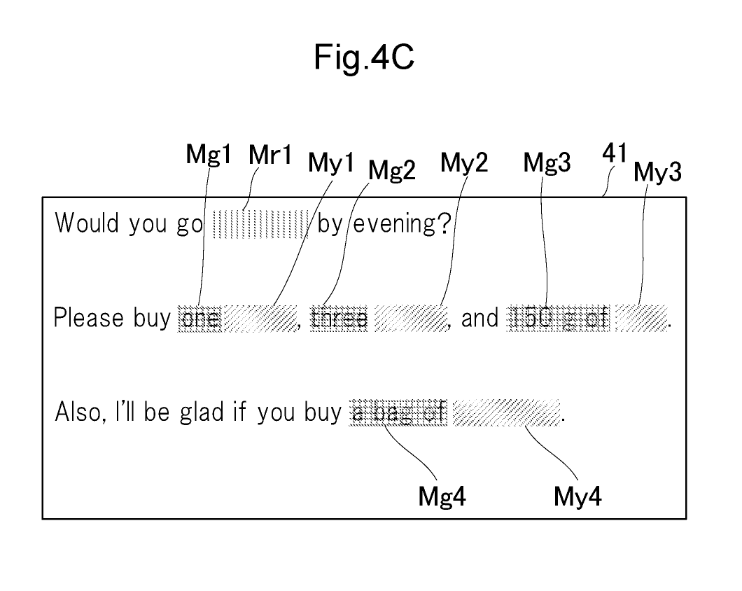

In the information processing apparatus 30, based on the markup data, the character string “shopping” at the red marker location Mr1, the character strings “carrot”, “apples”, “beef”, and “chocolate” at the yellow marker locations My1 to My4, and the character strings “one”, “three”, “150 g of” “a bag of” at the green marker locations Mg1 to Mg4 are set at red, yellow, and green, respectively, on the screen of the display section 41 as shown in FIG. 3B. Thus, the character strings at these marker locations are invisible. Furthermore, for example, when the user points at the red marker location Mr1 with a fingertip or the like on the screen of the display section 41, the color of the character string “shopping” at the red marker location Mr1 is switched to black, as shown in FIG. 4A, based on the markup data, thus making the character string “shopping” visible.

Moreover, when the user points at any one of the yellow marker locations My1 to My4 with a fingertip or the like on the screen of the display section 41, the color of the character strings “carrot”, “apples”, “beef”, and “chocolate” at the yellow marker locations My1 to My4 is switched to black, as shown in FIG. 4B, based on the markup data, thus making the character strings “carrot”, “apples”, “beef”, and “chocolate” visible.

Likewise, when the user points at any one of the green marker locations Mg1 to Mg4 with a fingertip or the like on the screen of the display section 41, the color of the character strings “one”, “three”, “150 g of”, and “a bag of” at the green marker locations Mg1 to Mg4 is switched to black, as shown in FIG. 4C, based on the markup data, thus making the character strings “one”, “three”, “150 g of”, and “a bag of” visible.

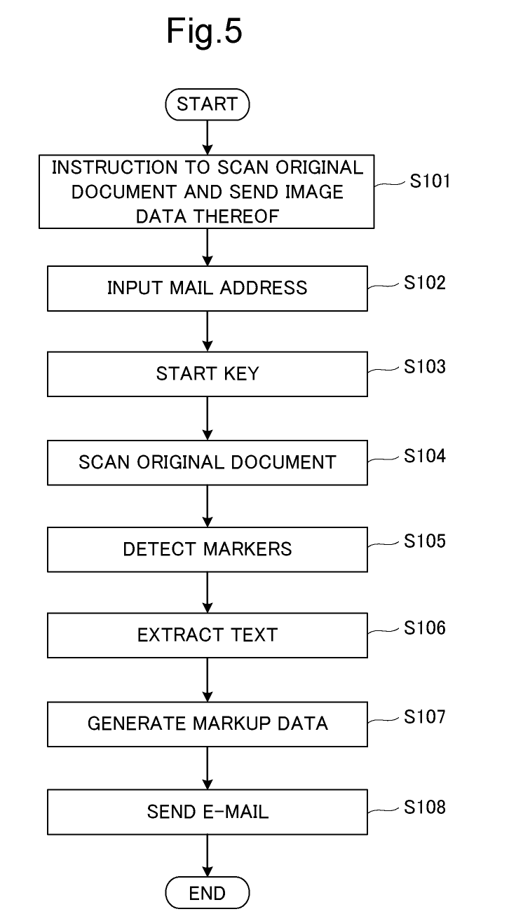

Next, a description will be given of a processing procedure on the image forming apparatus 10 for recognizing and extracting a text in an original document G, converting the display manners of character strings at marker locations and the display manners of the markers into markup data, inserting the markup data into the body of an e-mail, and sending the e-mail, with reference to a flowchart shown in FIG. 5.

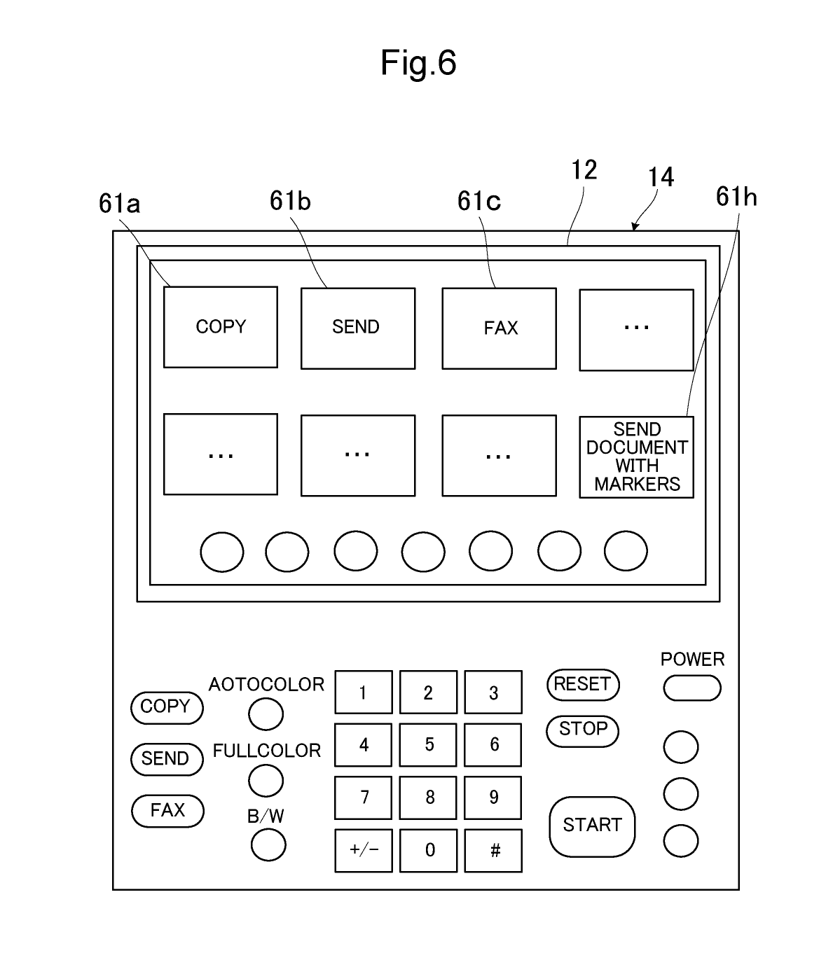

First, suppose that a plurality of touch keys 61a to 61h associated with their respective functions and other keys are displayed on the screen of the display section 12 of the image forming apparatus 10 as shown in FIG. 6. When in this state a user makes a touch gesture on a touch key 61h associated with the sending of an original document with markers, the touch panel 15 detects the touch gesture on the touch key 61h, the gesture and operation acceptance section 22 thus accepts the touch gesture, and the control section 21 runs the function (an application program) to scan the original document with markers and send it (step S101).

Subsequently, the user operates the operating section 14 to input a mail address indicating the other party for sending the original document (step S102). In doing so, with an entry screen for the mail address displayed on the display section 12, the user may perform an input operation on the entry screen.

Furthermore, the user places an original document in the image scanning section 17 and operates the start key of the operating section 14. When the gesture and operation acceptance section 22 accepts the operation of the start key (step S103), the control section 21 starts the image scanning section 17 to allow the image scanning section 17 to scan the original document and allows the storage section 19 to store image data representing an image of the original document (step S104).

During the time, the marker detecting section 25 analyzes the image data to sequentially detect markers assigned to the original document (step S105) and gives the markup language processing section 27 marker locations in the original document where the markers are assigned. Furthermore, the OCR processing section 26 analyzes the image data representing the original document to recognize and extract a text in the original document and allows the storage section 19 to store the text (step S106).

The markup language processing section 27 extracts character strings at the marker locations from the text and generates markup data for setting the character string at each marker location and the associated marker at the same color and for switching, in response to pointing at any marker location, the color of the character string at the marker location to black (step S107).

In doing so, if in the text a plurality of types of marker locations are set, markup data is generated differently for each type of marker location. For example, when, as shown in FIG. 3A, the red marker location Mr1, the four yellow marker locations My1 to My4, and the four green marker locations Mg1 to Mg4 are set in the text, markup data is generated, on a color-by-color basis of the red, yellow, and green markers, for setting the character string at each marker location and the associated marker at the same color and setting the function to switch, in response to pointing at any marker location, the color of the character string at the marker location to black.

Then, the communication control section 24 generates an e-mail addressed to the mail address input in step S102, inserts the markup data generated by the processing in steps S104 to S106 into the body of the e-mail, and send the e-mail through the communication section 16 to the network (step S108).

Through the above processing procedure on the image forming apparatus 10, such a text in the original document G as shown in FIG. 3A is extracted, markup data is generated, on a type-by-type basis of marker location, for setting the character string at each marker location and the associated marker at the same color and setting the function to switch, in response to pointing at any marker location, the color of the character string at the marker location to a different color, the markup data is inserted into the body of the e-mail, and the e-mail is sent to the information processing apparatus 30.

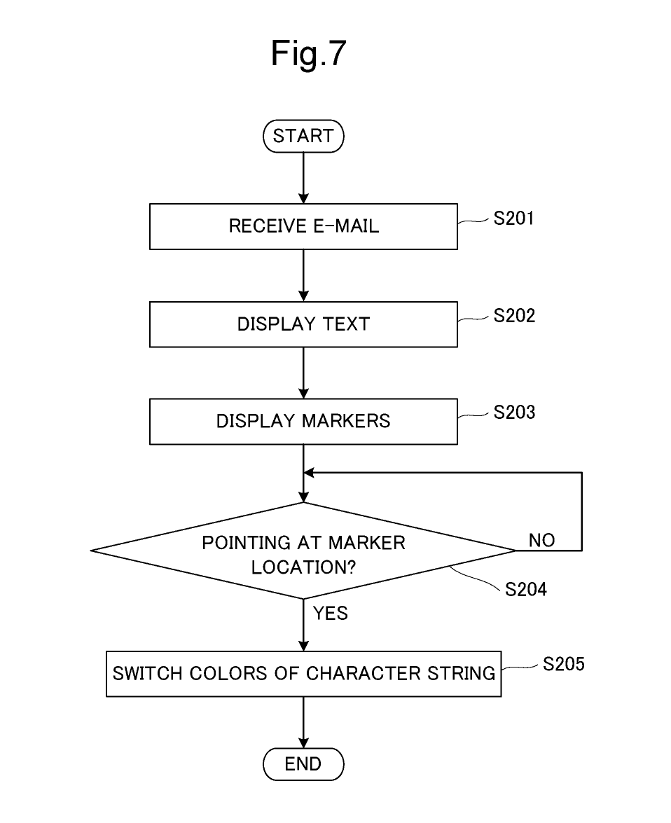

Next, a description will be given of a processing procedure on the information processing apparatus 30 for receiving the e-mail, interpreting the markup data in the body of the e-mail, displaying the text (containing the character strings at the marker locations) together with the markers, and switching the color of a character string at a marker location to black in response to pointing at the marker location, with reference to a flowchart shown in FIG. 7.

When in the information processing apparatus 30 the communication section 45 receives the e-mail sent from the image forming apparatus 10 (step S201), the display control section 53 allows the display section 41 to display the e-mail and the text in the body of the e-mail on the screen (step S202). In doing so, the markup language processing section 55 interprets the markup data, the display control section 53 allows the display of the markers superposed on the character strings of the text based on the markup data, and the markup language processing section 55 sets the character string at each marker location and the associated marker at the same color (step S203). Thus, the text (containing the character strings at the marker locations) and the markers are displayed in the body of the e-mail. Furthermore, the character strings at all the marker locations are invisible on the screen of the display section 12.

When in this state the user points at a marker location with a fingertip or the like (“YES” in step S204), the touch panel 42 detects a touch gesture on the marker location and the gesture and operation acceptance section 52 accepts the touch gesture. Then, the display control section 53 switches, based on the markup data, the color of the character string at the marker location subjected to the touch gesture to black (step S205). Furthermore, if there is in the text any other marker location having the same color as the marker location where the user has pointed, the color of the character string at the other marker location is also switched to black. For example, when the red marker location Mr1 is touched, the color of the character string “shopping” at the red marker location Mr1 is switched to black as shown in FIG. 4A. Alternatively, when any one of the yellow marker locations My1 to My4 is touched, the color of the character strings “carrot”, “apples”, “beef”, and “chocolate” at all the yellow marker locations My1 to My4 is switched to black as shown in FIG. 4B. In other words, not only the color of a character string at a touched marker location is switched to black, but also the color of character string at every other marker location having the same color as the touched marker location is switched to black, so that the character strings at these marker locations become visible.

As thus far described, in this embodiment, a text in an original document is recognized and markup data representing the display manners of character strings at marker locations in the text and the display manners of markers is previously generated. Then, in displaying the text (containing the character strings at the marker locations) and the markers, the color of the character string at each marker location is set at the same color as the associated marker based on the markup data so that the character strings at all the marker locations become invisible. When the user points at any marker location, the color of the character string at the marker location is switched to a color different from the color of the associated marker to turn the character string visible. This switching of colors of the character string at the marker location is useful, for example, for memorizing the character string.

The present disclosure is not limited to the configurations of the above embodiment and can be modified in various ways.

For example, although in the above embodiment the color of a character string at a touched marker location is switched to black, the color of the character string may be switched to another color or may be made transparent. Alternatively, while the color of the character string at the touched marker location is kept unchanged, the color of the marker may be switched to a different color or made transparent.

Furthermore, when either one of the color of the character string at the touched marker location and the color of the marker is switched to a different color and the same marker location is then touched again, the color of the character string at the marker location or the color of the marker may be turned back to the original color and reset so that the character string becomes invisible. In this relation, the markup language processing section 55 performs processing for incorporating into the above processing procedure a procedure for, if either one of the color of the text portion at the marker location and the color of the marker is switched to a different color in response to pointing at the marker location and the user then points at the marker location again, turning the color of the character string at the marker location or the color of the marker back to the original color.

The markup data may be set as an e-mail attachment and the e-mail may be sent from the image forming apparatus 10 to the information processing apparatus 30.

Moreover, the processing for interpreting markup data, displaying the text (containing character strings at marker locations) together with markers, and switching the color of a character string at a marker location to a color different from the color of an associated marker in response to pointing at the marker location may be executed on the image forming apparatus 10.

Furthermore, the markup language processing section 27 of the image forming apparatus 10 may have the function which the markup language processing section 55 of the information processing apparatus 30 has. In this case, when the user points at a marker location through the gesture and operation acceptance section 52, the markup language processing section 27 switches, based on the processing procedure contained in the markup data, either one of the color of the text portion at the marker location and the color of the marker to a different color.

Moreover, in the processing at step S107 shown in the flowchart of FIG. 5, the markup language processing section 27 may generate, together with markup data, data (for example, text data) in which character strings at marker locations are picked up.

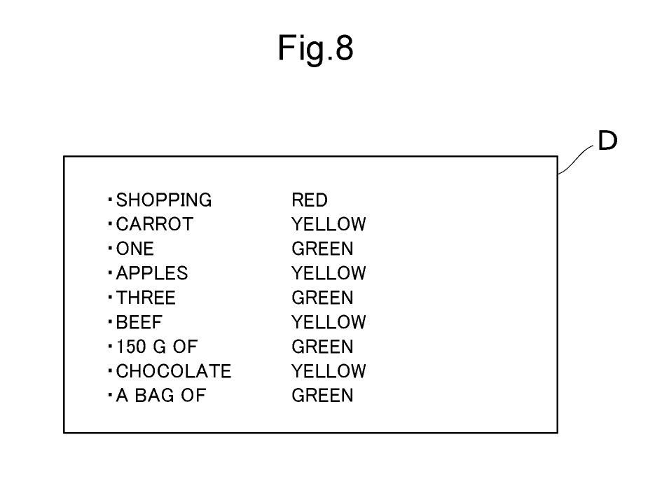

FIG. 8 is a view showing an example of text data D generated by the markup language processing section 27 based on the original document G shown in FIG. 3A. Referring to this figure, the markup language processing section 27 generates text data D in which the character strings at the marker locations shown on the original document G are listed in correspondence with the colors of the marker locations. The image forming apparatus 10 may allow the display section 12 to display the text data D in response to a user's instruction accepted by the gesture and operation acceptance section 22. In this manner, the user can be notified of a list of concealed character strings.

Furthermore, the communication control section 24 may send the text data together with the markup data to the information processing apparatus 30 by e-mail. In this manner, in the information processing apparatus 30, the list of concealed character strings can be displayed on the display section 41 according to a user's instruction accepted by the gesture and operation acceptance section 52.

Various modifications and alterations of this disclosure will be apparent to those skilled in the art without departing from the scope and spirit of this disclosure, and it should be understood that this disclosure is not limited to the illustrative embodiments set forth herein.

What is claimed is:

1. An image processing apparatus comprising:
an acquisition section that acquires image data representing an image of an original document;
a marker detecting section that detects, based on the image data, a marker assigned to the original document;
a text extracting section that analyzes the image data to recognize and extract a text in the original document; and
a markup language processing section that generates markup data written in a markup language and containing: the text extracted by the text extracting section; and data representing a display manner of the marker detected by the marker detecting section, the markup language processing section generating as the markup data markup data in which the text in the image data has the same display color as the marker.

2. The image processing apparatus according to claim 1, wherein in generating the markup data, the markup language processing section performs processing for incorporating into the markup data a processing procedure for switching, in response to pointing at a marker location in the text where the marker is assigned, either one of the color of a portion of the text located at the marker location and the color of the marker to a different color.

3. The image processing apparatus according to claim 2, further comprising:
a display section that displays, based on the markup data, the text together with the marker; and
an operating section through which a user points at the marker location displayed on the display section,
wherein upon pointing at the marker location through the operating section, the markup language processing section switches, based on the processing procedure contained in the markup data, either one of the color of the portion of the text located at the marker location and the color of the marker to the different color.

4. The image processing apparatus according to claim 3, wherein
the markup language processing section generates, together with the markup data, data in which the portion of the text located at the marker location detected by the marker detecting section is picked up, and
the display section displays, in response to an operation accepted by the operating section, the portion of the text represented by the data.

5. The image processing apparatus according to claim 3, wherein the markup language processing section performs processing for incorporating into the processing procedure a procedure for, if either one of the color of the portion of the text located at the marker location and the color of the marker is switched to the different color in response to pointing at the marker location and the user then points at the marker location again, turning the color of the portion of the text located at the marker location or the color of the marker back to an original color.

6. An image processing system that performs data communication between an image processing apparatus and an information processing apparatus,
the image processing apparatus comprising:
an acquisition section that acquires image data representing an image of an original document;
a marker detecting section that detects, based on the image data, a marker assigned to the original document;
a text extracting section that analyzes the image data to recognize and extract a text in the original document; and
a markup language processing section that generates markup data written in a markup language and containing: the text extracted by the text extracting section; and data representing a display manner of the marker detected by the marker detecting section, the markup language processing section generating as the markup data markup data in which the text in the image data has the same display color as the marker; and
a transmission section that sends the markup data to the information processing apparatus,
the information processing apparatus comprising:
a receiving section that receives the markup data; and
a display section that displays, based on the markup data, the text together with the marker.
